(19) United States
(12) Patent Application Publication
(10) Pub. No.: US 2026/0342960 A1
(43) Pub. Date: Oct. 29, 2026

(54) A DISPLAY DEVICE

(71) Applicant: LG ELECTRONICS INC., Seoul (KR)

(72) Inventors: Ileun KWAK, Seoul (KR); Sungwon HONG, Seoul (KR)

(73) Assignee: LG ELECTRONICS INC., Seoul (KR)

(21) Appl. No.: 19/109,913

(22) PCT Filed: Sep. 7, 2022
(86) PCT No.: PCT/KR2022/013431

§ 371 Date: Mar. 7, 2025

(51) Int. Cl. H04N 17/00

(52) U.S. Cl. CPC H04N 17/00

(57) ABSTRACT

A display device according to an embodiment of the present disclosure comprises: a display module; and a main module for transmitting video signals to the display module so that the display module displays a video, wherein the main module can transmit, to the display module, test signals for detecting a transmission environment of the video signals.

### TECHNICAL FIELD

The present disclosure relates to a display device.

### BACKGROUND ART

Timing controller (T-CON) is a semiconductor for display that improves image quality by controlling an amount of data transmitted/transferred to DDI (Display Driver IC). Previously, a timing controller was equipped in the display module, but recently, it is being internalized in the SoC (System On Chip) of the main board.

If the timing controller is internalized in the SoC, the signal transmitted from the main board to the display module may deteriorate due to the electrical tolerance of the panel and the surrounding environment (e.g., temperature), which may cause the video to not be displayed properly. In addition, as the resolution of the display device increases, the speed of the transmission signal increases, making it difficult to control the quality of the signal, which causes the signal to be distorted more sensitively to the tolerance of the component and the surrounding environment.

Therefore, a method is required to prevent the video from not being displayed by maintaining the quality of the signal regardless of the electrical deviation of the component and the surrounding environment.

### DISCLOSURE

### Technical Problem

The present disclosure seeks to provide a display device that compensates for signals so as to minimize quality degradation of signals transmitted from a main module to a display module regardless of electrical deviations of components and the surrounding environment.

### Technical Solution

A display device according to an embodiment of the present disclosure comprises a display module and a main module configured to transmit video signals to the display module so that a video is displayed on the display module, and wherein the main module is configured to transmit test signals for detecting a transmission environment of the video signals to the display module.

The main module is configured to adjust a video signal transmitted to the display module based on a feedback signal responsive to the test signals received from the display module.

The main module is configured to transmit the test signals between the video signals.

The main module is configured to transmit the test signals during blank period between transmission periods of the video signals, wherein the blank period is a period that the video signals are not transmitted.

The main module is configured to continuously adjust a signal compensation level of the video signal by transmitting the test signals at each blank period.

Each of the test signals includes a preset pattern, and the display module is configured to transmit the feedback signal including an error detection result of the preset pattern to the main module.

Each of the test signals includes a different pattern.

The main module is configured to transmit a first test signal including a first pattern and then change the signal compensation level of the video signals to a first level when an error is detected in the first test signal, and transmit a second test signal including a second pattern with a higher recognition difficulty than the first pattern if an error is not detected in the first test signal and then change the signal compensation level of the video signals to a second level lower than the first level when an error is detected in the second test signal.

The main module is configured to change the signal compensation level by changing at least one of the signal level and a pre-emphasis value.

The main module is configured to transmit a first feedback signal and a second feedback signal, respectively, in response to the first test signal and the second test signal, to the main module.

The main module is configured to transmit one feedback signal responsive to the first test signal and the second test signal to the main module.

The main module is configured to adjust the signal compensation level of the video signals and then transmit a response signal to the display module.

The main module comprises a panel, a gate driver for supplying a scan signal to the panel, and a source driver for supplying a video signal to the panel, wherein the main module includes a timing controller for controlling the gate driver and the source driver.

### Advantageous Effects

According to an embodiment of the present disclosure, since the transmission environment of a video signal can be detected by utilizing a blank period in which a video signal is not transmitted, there is an advantage in that the quality of a video signal can be detected and maintained in real time.

According to an embodiment of the present disclosure, there is an advantage in that overcompensation of a signal can be prevented by stepwise transmitting a test signal for detecting the transmission environment of a video signal and differently adjusting the signal compensation level accordingly.

### DESCRIPTION OF DRAWINGS

FIG. 1 is a schematic diagram illustrating the configuration of a display device according to an embodiment of the present disclosure.

FIG. 2 is a diagram illustrating an eye diagram for explaining a distortion occurring in a video signal when the surroundings of the display device are high temperature.

FIG. 3 is a schematic diagram illustrating a display device according to an embodiment of the present disclosure transmitting and receiving a test signal and a feedback signal.

FIG. 4 is a diagram illustrating a display device according to the first embodiment of the present disclosure transmitting and receiving a test signal and a feedback signal.

FIG. 5 is a diagram illustrating a display device according to the second embodiment of the present disclosure transmitting and receiving a test signal and a feedback signal.

FIG. 6 is a flowchart illustrating a method for a display device according to an embodiment of the present disclosure to adjust a signal compensation level based on a test signal and a feedback signal.

### BEST MODEL

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

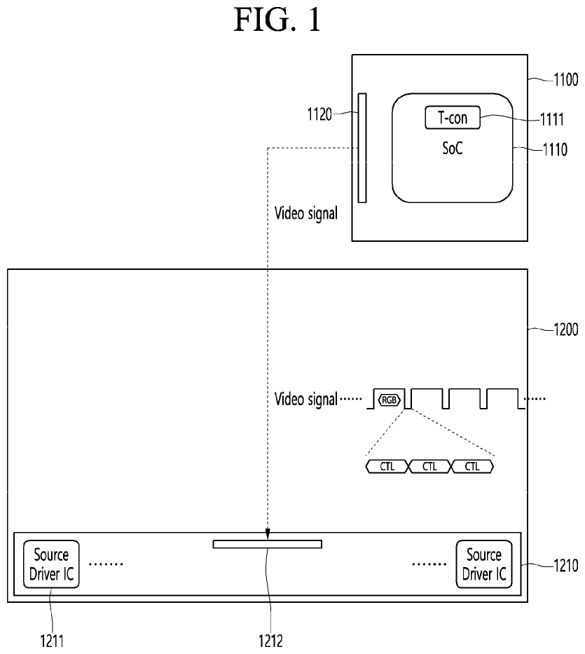

FIG. 1 is a schematic diagram illustrating the configuration of a display device according to an embodiment of the present disclosure.

The display device according to the embodiment of the present disclosure may include a main module 1100 and a display module 1200. That is, the configuration of the display device according to the embodiment of the present disclosure may be largely divided into a main module 1100 and a display module 1200.

The main module 1100 may control the overall operation of the display device. The main module 1100 may control a broadcast receiver (not shown), a speaker (not shown), a wireless communication interface (not shown), etc., including the display module 1200. The main module 1100 may transmit video signals to the display module 1200 so that video is displayed on the display module 1200.

The main module 1100 may include a SoC (System on Chip, 1110) capable of processing all functions of the display device. The main module 1100 may further include a communication interface 1120 for communicating with the display module 1200.

The display module 1200 may include a panel (not shown) and various components related to driving the panel. The panel (not shown) may be of various types, such as a liquid crystal display panel (LCD panel), an organic light-emitting panel (OLED panel), or an inorganic light-emitting panel (LED panel).

In addition, various components related to the driving of the panel may be a driving circuit unit that drives the panel. The driving circuit unit may include a DDI (Display Driver IC) including a gate driver and a source driver, a panel driving power supply unit, etc.

The gate driver (not shown) serves as an on/off switch for subpixels and may supply a scanning signal to the panel. The source driver 1211 can create differences in colors to be expressed by subpixels and supply video signals to the panel. There can be at least one gate driver and one source driver.

For example, the source driver 1211 may be provided on the source PCB (1210). The source PCB 1210 may include at least one source driver 1211 and a communication interface 1212, and the communication interface 1212 may transmit and receive signals with the main module 1100.

The gate driver (not shown) and the source driver 1211 may be controlled by a timing controller 1111. Specifically, the timing controller 1111 may receive a control signal, an R, G, B data signal, a vertical synchronization signal (Vsync), etc. from the main controller (not shown) of the SoC 1110, control the gate driver (not shown) and the source driver 1211 in response to the control signal, and rearrange the R, G, B data signals to provide them to the source driver 1211. The source driver 1211 may be a data driver.

Meanwhile, the timing controller 1111, which receives a video signal, a control signal, a vertical synchronization signal, etc. and controls the gate driver and the source driver, used to be equipped as a component of the conventional driving circuit, but has recently been internalized in the SoC 1110. The present disclosure relates to a display device in which the timing controller 1111 is included in the SoC 1110. That is, the present disclosure aims to improve a problem that occurs when the timing controller 1111 is included in the SoC 1110. However, even if the timing controller 1111 is a component of the driving circuit, as described below, the present disclosure can be applied when signal quality management is required due to the influence of the electrical tolerance of the panel or the surrounding environment. That is, the present disclosure can be applied when the timing controller 1111 is included in the display module 1200 as well as the main module 1100.

A problem in which the video signal deteriorates due to the influence of the electrical tolerance of the panel or the surrounding environment (temperature, etc.) and the video is not output normally may occur. For example, since the signal level or pre-emphasis value is fixed, the problem of the video signal not being optimized under certain conditions may occur. In addition, as the resolution of the video increases, the transmission signal speed increases, making it difficult to control the quality of the signal, and the problem of the signal being distorted more sensitively to the tolerance of the component and the surrounding environment may occur. In addition, if the timing controller 1111 is included in the SoC 1110, the transmission path of the video signal becomes longer, which may cause the above-described problems to occur more seriously.

Referring to FIG. 1, a video signal is transmitted from the main module 1100 to the source PCB 1210 through the communication interfaces 1120 1212, but the video signal may be distorted due to the amount of video data, increased transmission speed, electrical tolerance of the panel, and the surrounding environment.

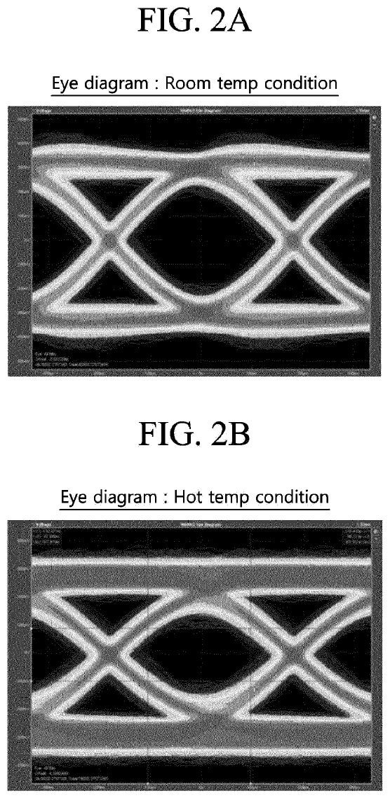

FIG. 2 is a drawing illustrating an eye diagram for explaining how distortion occurs in a video signal when the surroundings of the display device are at high temperature.

FIG. 2A may be an eye diagram of a video signal transmitted from the main module 1100 to the display module 1200 under room temperature conditions, and FIG. 2B may be an eye diagram of a video signal transmitted from the main module 1100 to the display module 1200 under high temperature conditions.

Comparing FIG. 2A and FIG. 2B, it can be confirmed that the size of the eye opening decreases as the swing level and rising/falling time of the video signal decrease as the temperature increases, and thus the quality of the video signal deteriorates.

Therefore, the present disclosure aims to minimize the quality deterioration of the video signal by adjusting the degree of signal compensation, such as the signal level or pre-emphasis value, according to the quality of the transmitted video signal.

In a display device according to an embodiment of the present disclosure, the main module 1100 transmits test signals for detecting the transmission environment of video signals to the display module 1200, and the display module 1200 transmits a feedback signal in response to the test signals to the main module 1100, thereby detecting the transmission environment and adjusting the signal compensation level according to the detection results.

Specifically, the test signals are predetermined between the main module 1100 and the display module 1200, so that the display module 1200 can determine whether a received test signal matches a predetermined test signal, and transmit information about the same to the main module 1100 as a feedback signal, so that the main module 1100 can obtain the transmission environment of the video signals. That is, the main module 1100 can adjust a video signal transmitted to the display module 1200 based on a feedback signal in response to the test signals received from the display module 1200.

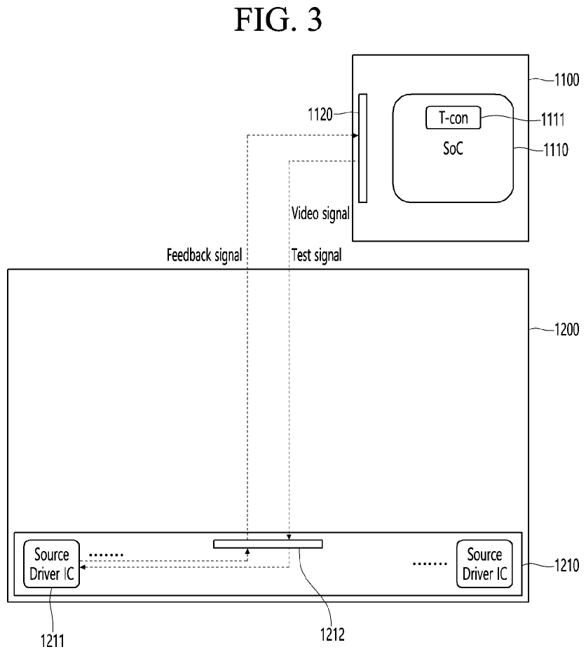

FIG. 3 is a schematic diagram illustrating a display device according to an embodiment of the present disclosure transmitting and receiving a test signal and a feedback signal.

The main module 1100 can transmit a test signal as well as a video signal to the display module 1200 through the communication interface 1120. The communication interface 1212 of the display module 1200 can receive the video signal and the test signal from the main module 1100. The communication interface 1212 can transmit the video signal and the test signal to the source driver 1211.

The video signal can be a signal including video data, i.e., R, G, B data. The source driver 1211 can supply a voltage corresponding to each color value according to the R, G, B data when receiving the video signal.

The test signal can include a preset pattern. There can be a plurality of test signals, and in this case, the patterns included in each of the test signals can be different.

When receiving a test signal, the source driver 1211 can compare the pattern of the received test signal with a preset pattern. The source driver 1211 can determine whether the pattern of the received test signal matches the preset pattern. That is, the source driver 1211 can detect an error based on whether the pattern of the received test signal matches the preset pattern.

The source driver 1211 can determine that no error has occurred if the pattern of the received test signal matches the preset pattern, and can determine that an error has occurred if the pattern of the received test signal is different from the preset pattern.

The feedback signal may include an error detection result in a pattern included in the test signal. The source driver 1211 may transmit a feedback signal to the main module 1100 through the communication interface 1212 based on whether a detected error has occurred.

The main module 1100 may adjust a video signal transmitted to the display module 1200 based on the feedback signal. That is, the main module 1100 may adjust a signal compensation level of the video signals based on the feedback signal. The main module 1100 may adjust a signal compensation level of the video signals based on the feedback signal. For example, the main module 1100 may adjust a signal compensation level by adjusting at least one of a signal level and a pre-emphasis value.

The main module 1100 may transmit a response signal to the display module 1200 after adjusting the signal compensation level of the video signals. For example, the main module 1100 can adjust the signal compensation level of the video signals and then transmit an acknowledgment signal (ACK) to the display module 1200.

Meanwhile, the main module 1100 can have a blank period (video black period) in which the video signals are not transmitted when transmitting the video signals. That is, the main module 1100 can have a video period in which the video signals corresponding to each frame are transmitted, and can have a blank period between the video periods. The blank period can be a period in which a training pattern for generating a reference signal of clocks, a control signal (CTL), etc. are transmitted.

The main module 1100 can transmit test signals to the display module 1200 in the blank period. That is, the main module 1100 can detect the transmission environment of the video signals in the blank period. The main module 1100 can evaluate the quality of video signals transmitted in a blank period and automatically tune the transmission signal based on the evaluation result signal (feedback signal) to maintain the signal quality.

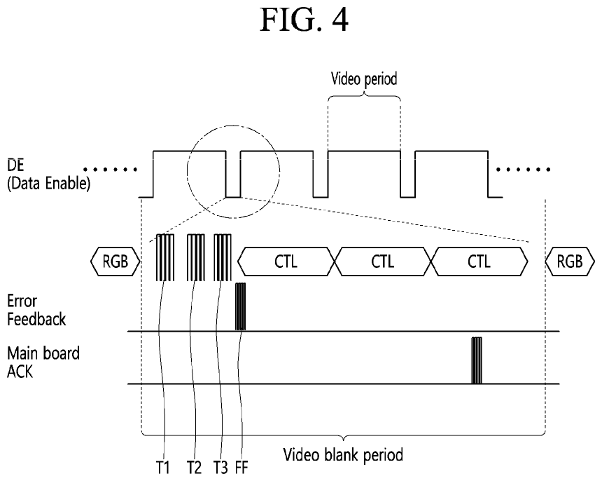

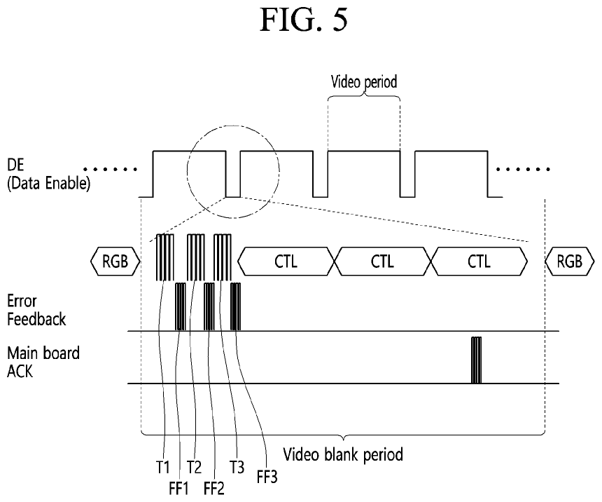

FIG. 4 is a drawing illustrating a display device according to the first embodiment of the present disclosure transmitting and receiving a test signal and a feedback signal, and FIG. 5 is a drawing illustrating a display device according to the second embodiment of the present disclosure transmitting and receiving a test signal and a feedback signal.

In FIGS. 4 and 5, the first to third test signals T1 T2 T3, that is, three test signals are transmitted during the blank period, but this is merely an example for convenience of explanation, and less than three or more than three test signals may be transmitted.

In the first embodiment, as illustrated in FIG. 4, the display module 1200 transmits one feedback signal FF after receiving all of the first to third test signals T1 T2 T3. In this case, the feedback signal FF may include an error detection result for each of the first to third test signals T1 T2 T3. The display module 1200 can transmit one feedback signal FF in response to the first to third test signals T1 T2 T3 to the main module 1100.

The second embodiment is a case where the display module 1200 transmits the first to third feedback signals FF1 FF2 FF3 for the first to third test signals T1 T2 T3, respectively, as illustrated in FIG. 5. In this case, the first feedback signal FF1 may include an error detection result for the first test signal T1, the second feedback signal FF2 may include an error detection result for the second test signal T2, and the third feedback signal FF3 may include an error detection result for the third test signal T3. That is, the display module 1200 may transmit the first to third feedback signals FF1 FF2 FF3, respectively, in response to the first to third test signals T1 T2 T3, respectively, to the main module 1100.

The main module 1100 can adjust the signal compensation level of the video signals based on the integrated feedback signal or the individual feedback signal for the plurality of test signals T1 T2 T3 and then transmit a response signal to the display module 1200.

Meanwhile, in the first and second embodiments, each of the plurality of test signals T1 T2 T3 can include different patterns. That is, the main module 1100 can transmit the plurality of test signals including different patterns to the display module 1200.

In addition, each pattern included in the plurality of test signals can have different recognition difficulties.

The source driver 1211 may be configured to recognize high or low in the test signal. For example, if the source driver 1211 is configured to recognize high, the longer the duration of high, the lower the recognition difficulty, and the shorter the duration of high, the higher the recognition difficulty. Conversely, if the source driver 1211 is configured to recognize low, the longer the duration of low, the lower the recognition difficulty, and the shorter the duration of low, the higher the recognition difficulty. In this specification, for convenience of explanation, it is assumed that the source driver 1211 is configured to recognize high.

The main module 1100 can transmit a first test signal including a first pattern, a second test signal including a second pattern, and a third test signal including a third pattern to the display module 1200, and at this time, the recognition difficulty of the first pattern may be lower than the recognition difficulty of the second pattern, and the recognition difficulty of the second pattern may be lower than the recognition difficulty of the third pattern. For example, the first pattern may be 01110111 . . . , the second pattern may be 00110011 . . . , and the third pattern may be 00010001.

The main module 1100 can transmit test signals to the display module 1200 starting from the order of low recognition difficulty, and when the signal compensation level is adjusted while gradually increasing the recognition difficulty in this way, there is an advantage of being able to prevent overcompensation of the signal.

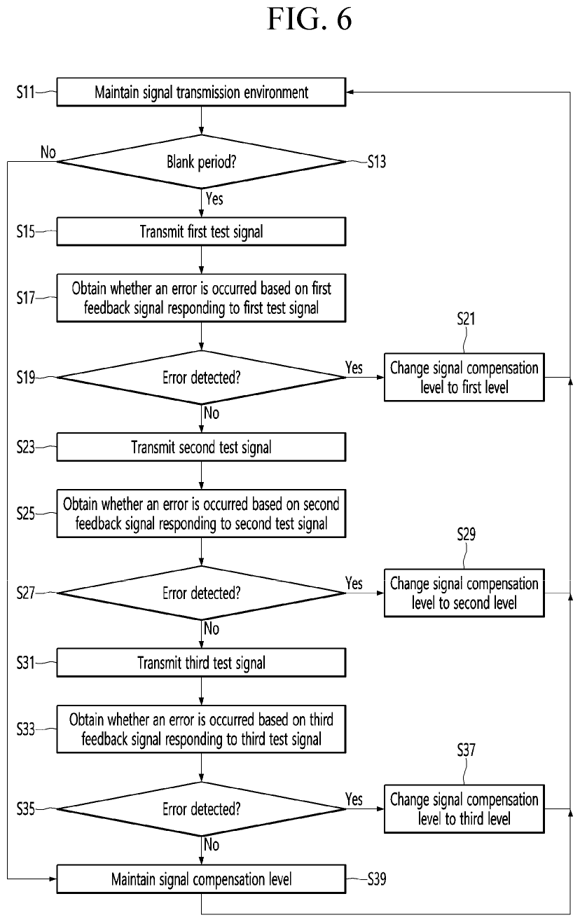

FIG. 6 is a flowchart illustrating a method for adjusting a signal compensation level based on a test signal and a feedback signal by a display device according to an embodiment of the present disclosure.

The main module 1100 can transmit a video signal to the display module 1200 (S11).

The video signal may be a signal including video data (R, G, B data). The main module 1100 transmits video signals corresponding to each frame, and a blank period may be formed between the video signals.

The main module 1100 can determine whether it is a blank period (S13).

The main module 1100 can continuously adjust the signal compensation level of the video signal by transmitting test signals at each blank period. That is, the main module 1100 can transmit test signals in the blank period where video signals are not transmitted between the transmission periods of the video signals. That is, the main module 1100 can transmit test signals between the video signals.

The main module 1100 can maintain the signal compensation level when it is not a blank period (S39).

When it is a blank period, the main module 1100 may transmit the first test signal to the display module 1200 (S15).

The first test signal can include a first pattern.

While the first test signal is transmitted from the main module 1100 to the display module 1200, an error may or may not occur in the first test signal.

The display module 1200 can receive the first test signal from the main module 1100. The source driver 1211 can detect whether an error occurs in the first test signal by recognizing a pattern included in the first test signal and determining whether it matches a preset first pattern. If an error occurs in the first test signal, it can be determined that an error occurred because it does not match the preset first pattern. If an error does not occur in the first test signal, it can be determined that an error did not occur because it matches the preset first pattern.

The display module 1200 can transmit a first feedback signal including a detection result of whether an error has occurred to the main module 1100.

The main module 1100 can obtain whether an error has occurred based on the first feedback signal responding to the first test signal (S17).

The main module 1100 can determine whether an error has been detected (S19), and if an error has been detected, change the signal compensation level to the first level (S21), and if an error has not been detected, transmit a second test signal (S23).

The second test signal can include a second pattern having a higher recognition difficulty than the first pattern.

While the second test signal is transmitted from the main module 1100 to the display module 1200, an error may or may not occur in the second test signal.

The display module 1200 can receive the second test signal from the main module 1100. The source driver 1211 can detect whether an error occurs in the second test signal by recognizing the pattern included in the second test signal and determining whether the recognized pattern matches the preset second pattern. If an error occurs in the second test signal, it can be determined that an error occurred because the recognized pattern does not match the preset second pattern. If an error does not occur in the first test signal, it can be determined that an error did not occur because the recognized pattern matches the preset second pattern.

The display module 1200 can transmit a second feedback signal including the detection result of whether an error occurred to the main module 1100.

The main module 1100 can obtain whether an error occurs based on the second feedback signal responding to the second test signal (S25).

The main module 1100 determines whether an error is detected (S27), and if an error is detected, changes the signal compensation level to the second level (S29), and if an error is not detected, transmits a third test signal (S31).

The third test signal may include a third pattern having a higher recognition difficulty than the second pattern.

While the third test signal is transmitted from the main module 1100 to the display module 1200, an error may or may not occur in the third test signal.

The display module 1200 can receive the third test signal from the main module 1100. The source driver 1211 can detect whether an error occurs in the third test signal by recognizing the pattern included in the third test signal and determining whether the recognized pattern matches the preset third pattern. If an error occurs in the third test signal, it can be determined that an error occurred because the recognized pattern does not match the preset third pattern. If an error does not occur in the third test signal, it can be determined that an error did not occur because the recognized pattern matches the preset third pattern.

The display module 1200 can transmit a third feedback signal including the detection result of whether an error occurred to the main module 1100.

The main module 1100 can obtain whether an error occurs based on the third feedback signal responding to the third test signal (S33).

The main module 1100 determines whether an error is detected (S35), and if an error is detected, changes the signal compensation level to the third level (S37), and if an error is not detected, maintains the signal compensation level (S39).

At this time, the first level may have a higher signal compensation level than the second level, and the second level may have a higher signal compensation level than the third level.

In summary, the main module 1100 transmits a first test signal including a first pattern, and if an error is detected in the first test signal, changes the signal compensation level of the video signals to the first level, and if no error is detected in the first test signal, transmits a second test signal including a second pattern having a higher recognition difficulty than the first pattern, and if an error is detected in the second test signal, changes the signal compensation level of the video signals to the second level lower than the first level, . . . , if no error is detected in the n-1th test signal, transmits an n-th test signal including an n-th pattern having a higher recognition difficulty than the n-1th pattern, and if an error is detected in the n-th test signal, changes the signal compensation level of the video signals to the n-th level lower than the n-1th level.

That is, the main module 1100 can increase the signal compensation level as the recognition difficulty of the pattern included in the test signal in which an error is detected is lower, and can decrease the signal compensation level as the recognition difficulty of the pattern included in the test signal in which an error is detected is higher.

The main module 1100 can change the signal compensation level by changing at least one of the signal level and the pre-emphasis value of the transmission signal.

The signal level can mean the swing level of the signal. The pre-emphasis value can mean the emphasis (amplification) level of the high-frequency spectrum component.

The main module 1100 can increase the signal compensation level by increasing at least one of the signal level and the pre-emphasis value.

The main module 1100 can increase at least one of the signal level and the pre-emphasis value as the recognition difficulty of the pattern included in the test signal from which an error is detected is lower, and can decrease at least one of the signal level and the pre-emphasis value as the recognition difficulty of the pattern included in the test signal from which an error is detected is higher.

The main module 1100 can adjust the signal compensation level of the video signals and then transmit a response signal to the display module 1200.

As described above, the present disclosure has the advantage of minimizing the degradation of signal quality by acquiring the transmission environment of the current video signal by transmitting a test signal using a blank period in which no video signal is transmitted, and adjusting the signal compensation level accordingly.

According to this, there is an advantage of improving the problem of the degradation of signal quality as the speed of the transmission signal increases due to the increase in the resolution of the display device.

In addition, since a serial communication line is used to transmit a video signal from the main module 1100 to the display module 1200 without installing a separate communication line, there is an advantage of being able to maintain real-time signal quality without additional costs.

According to one embodiment of the present invention, the above-described method can be implemented as a processor-readable code on a medium in which a program is recorded. Examples of the processor-readable medium include ROM, RAM, CD-ROM, magnetic tape, floppy disk, optical data storage device, etc.

The display device described above is not limited to the configuration and method of the embodiments described above, and the embodiments may be configured by selectively combining all or part of each embodiment so that various modifications can be made.

The above description is merely an example of the technical idea of the present disclosure, and those skilled in the art to which the present disclosure belongs will be able to make various modifications and variations without departing from the essential characteristics of the present disclosure.

Therefore, the embodiments disclosed in the present disclosure are not intended to limit the technical idea of the present disclosure but to explain it, and the scope of the technical idea of the present disclosure is not limited by these embodiments.

The scope of protection of the present disclosure should be interpreted by the claims below, and all technical ideas within the scope equivalent thereto should be interpreted as being included in the scope of the rights of the present disclosure.

1-13. (canceled)

14. A display device comprising:
a display module; and
a main module configured to transmit video signals to the display module so that a video is displayed on the display module, and
wherein the main module is configured to:
transmit test signals for detecting a transmission environment of the video signals to the display module.

15. The display device according to claim 14, wherein the main module is configured to:
adjust a video signal transmitted to the display module based on a feedback signal responsive to the test signals received from the display module.

16. The display device according to claim 14, wherein the main module is configured to:
transmit the test signals between the video signals.

17. The display device according to claim 14, wherein the main module is configured to:
transmit the test signals during blank period between transmission periods of the video signals, wherein the blank period is a period that the video signals are not transmitted.

18. The display device according to claim 14, wherein the main module is configured to:
continuously adjust a signal compensation level of the video signal by transmitting the test signals at each blank period.

19. The display device according to claim 17, wherein the blank period is a period in which a training pattern for generating a reference signal of clocks or a control signal (CTL) is transmitted.

20. The display device according to claim 15, wherein each of the test signals includes a preset pattern, and
the display module is configured to:
transmit the feedback signal including an error detection result of the preset pattern to the main module.

21. The display device according to claim 20, wherein each of the test signals includes a different pattern.

22. The display device according to claim 14, wherein the main module is configured to:
transmit a first test signal including a first pattern and then change the signal compensation level of the video signals to a first level when an error is detected in the first test signal, and
transmit a second test signal including a second pattern with a higher recognition difficulty than the first pattern if an error is not detected in the first test signal and then change the signal compensation level of the video signals to a second level lower than the first level when an error is detected in the second test signal.

23. The display device according to claim 22, wherein the main module is configured to:
change the signal compensation level by changing at least one of the signal level and a pre-emphasis value.

24. The display device according to claim 22, wherein the main module is configured to:
transmit a first feedback signal and a second feedback signal, respectively, in response to the first test signal and the second test signal, to the main module.

25. The display device according to claim 22, wherein the main module is configured to:
transmit one feedback signal responsive to the first test signal and the second test signal to the main module.

26. The display device according to claim 22, wherein the main module is configured to:
adjust the signal compensation level of the video signals and then transmit a response signal to the display module.

27. The display device according to claim 22, wherein the main module is configured to:
transmit a third test signal including a third pattern with a higher recognition difficulty than the second pattern if an error is not detected in the second test signal and then change the signal compensation level of the video signals to a third level lower than the second level when an error is detected in the third test signal.

28. The display device according to claim 27, wherein the main module is configured to:
maintain the signal compensation level when the error is not detected.

29. The display device according to claim 14, wherein the main module is configured to:
adjust the signal compensation level by transmitting test signals to the display module starting from an order of low recognition difficulty.

30. The display device according to claim 14, wherein the main module comprises:
a panel,
a gate driver for supplying a scan signal to the panel, and
a source driver for supplying a video signal to the panel,
wherein the main module includes a timing controller for controlling the gate driver and the source driver.

31. The display device according to claim 30, wherein source driver is configured to recognize high or low in the test signals.

32. The display device according to claim 30, wherein the source drive is configured to recognize high, the longer a duration of high, the lower a recognition difficulty of a pattern included in the test signals and the shorter the duration of high, the higher the recognition difficulty of the pattern included in the test signals.

33. The display device according to claim 30, wherein the source drive is configured to recognize low, the longer a duration of low, the lower a recognition difficulty of a pattern included in the test signals and the shorter the duration of low, the higher the recognition difficulty of the pattern included in the test signals.
